(19) United States
(12) Patent Application Publication
(10) Pub. No.: US 2024/0251789 A1
(43) Pub. Date: Aug. 1, 2024

(54) MARINE FEED ATTRACTANTS AND METHODS OF USE

(71) Applicant: Purina Animal Nutrition LLC, Arden Hills, MN (US)

(72) Inventors: Michael Burr, Marthasville, MO (US); Kara Dunmire, Manhattan, KS (US); Alysta Sewell, Gray Summit, MO (US); Michael Hayek, Ballwin, MO (US)

(21) Appl. No.: 18/423,627

(22) Filed: Jan. 26, 2024

Related U.S. Application Data
(60) Provisional application No. 63/482,213, filed on Jan. 30, 2023.

(51) Int. Cl. A01N 25/34; A01K 69/06; A01N 25/10; A01N 43/16; A01P 19/00

(52) U.S. Cl. CPC A01N 25/34; A01K 69/06; A01N 25/10; A01N 43/16; A01P 19/00

(57) ABSTRACT

Methods of attracting marine life and methods of stabilizing marine feeds or attractants in flowing water involve submerging stable marine attractant feed block products in water for at least 12 hours where a portion of the feed block dissociates from itself and another portion of the feed block remains intact after about 12 hours. Marine life is attracted to the dissociated portions of the feed block dissociated, and/or to the portion of the marine attractant feed block that remains intact. The feed block includes at least one of a marine feed or attractant, a binder composition, the binder composition comprising a hardening agent and a cross-linked edible polymer comprised of an edible acid and a gelatinized starch, and a sugar component, where the at least one of the marine feed or attractant is retained within a web defined by the binder and distributed throughout the marine attractant feed block.

### CROSS REFERENCE TO RELATED APPLICATIONS

This application claims priority to U.S. Provisional Patent Application No. 63/482,213 filed Jan. 30, 2023, entitled “MARINE FEED ATTRACTANTS AND METHODS OF USE” which is incorporated by reference herein, in its entirety and for all purposes.

### TECHNICAL FILED

Implementations are directed to stable marine feed attractant products suitable for ingestion by marine life, which serve to attract or induce feeding behavior, and methods for use of such products.

### BACKGROUND

The marine fishing industry, such as crab fishing, has seen a steadily declining availability of bait fish, also known as by-catch, due to changing environmental conditions. In addition, there are multiple drawbacks to using fish as an attractant including keeping the fish frozen for long periods of time, cleaning fish skeletal remains out of traps (e.g., cages or nets) after the marine life has been harvested, and the use of menhaden bait fish as fish meal in the animal feed industry, which competes with using this bait fish to attract marine life.

While artificial bait may be used as a substitution for this bait fish to attract marine life, known artificial baits lack stability for use in marine harvesting because these artificial baits quickly dissolve and dissociate and thus are ineffective for marine traps that are typically left submerged in a harvesting area for one to two days. Other artificial baits such as those described in U.S. Pat. No. 5,089,277 A include a moldable, putty-like consistency for being formed around a fishing hook that simulates the feeling of a live natural bait.

### SUMMARY

Methods of attracting marine life, methods of stabilizing marine feeds or attractants in flowing, and marine attractant feed blocks are provided.

According to implementations, a method of attracting marine life, involves submerging a marine attractant feed block in water for at least 12 hours, the marine attractant feed block comprising at least one of a marine feed or attractant, a binder composition, the binder composition comprising a hardening agent and a cross-linked edible polymer comprised of an edible acid and a gelatinized starch, and a sugar component, wherein the at least one of the marine feed or attractant is retained within a web defined by the binder and distributed throughout the marine attractant feed block. While the marine attractant feed block is submerged, a portion of the marine attractant feed block dissociates from the marine attractant feed block and another portion of the marine attractant feed block remains intact after about 12 hours. In response, marine life is attracted to one or more of the portion of the marine attractant feed block dissociated from the marine attractant feed block or to the portion of the marine attractant feed block that remains intact.

In various implementations and alternatives, the water is flowing water. In such implementations and alternatives, the flowing water is at a temperature of about 45° F. to about 90° F. or wherein the flowing water has a salinity of about 33 to about 37 grams per liter or salt at a level of about 33 to about 37 parts per thousand of water.

In various implementations and alternatives, the marine attractant feed block is substantially completely dissociated after about 18 to about 24 hours or after about 42 to about 48 hours.

In various implementations and alternatives, the marine life attracted is crustaceans. In addition or alternatively, the marine attractant feed block is arranged in a trap configured for holding the marine life, the marine attractant feed block has a length of at least 3 inches and volume of at least 21 cubic inches.

According to other implementations, a method of stabilizing at least one of a marine feed or attractant in flowing water, involves providing a hardened marine attractant feed block that retains an initial shape. The feed block may include at least one of a marine feed or attractant in a binder composition, the binder composition comprising a hardening agent and a cross-linked edible polymer, the cross-linked edible polymer comprising an edible acid and gelatinized starch and is hardened by the hardening agent, and wherein the at least one of the marine feed or attractant is present within a web defined by the binder and distributed throughout the marine attractant feed block. Then submerging the marine attractant feed block in the flowing water, wherein the initial shape of the marine attractant feed block gradually dissolves in the flowing water and releases the at least one of the marine feed or attractant residing at an exterior thereof, and at least a portion of the marine attractant feed block remains intact after about 12 hours.

In various implementations and alternatives, the released at least one of the marine feed or attractant attracts marine life to the intact portion of the marine attractant feed block for up to at least about 48 hours. In such implementations and alternatives, the marine attractant feed block may be arranged in a trap configured for holding the attracted marine life that reach the intact portion of the marine attractant feed block. In addition or alternatively, the flowing water is at least one of at a temperature of about 45° F. to about 90° F., or has a salinity of about 33 to about 37 grams per liter, or salt at a level of about 33 to about 37 parts per thousand of water.

According to further implementations, a stable marine attractant feed block product may include at least one of a marine feed or attractant; and a binder containing a hardening agent, and a cross-linked edible polymer, the hardening agent comprising one or more of magnesium oxide, calcium oxide, calcium hydroxide, and ionic salts of magnesium or calcium, the cross-linked edible polymer comprising an edible acid and gelatinized starch, wherein the at least one of the marine feed or attractant is present within a web defined by the binder.

In various implementations and alternatives, a sugar component is included, the product may have a hardness of about 15 to about 40 psi using a pin tester with a pin diameter of ⅜ in., the product may contain about 30 to about 50 wt. % of the binder, the one or more attractants or feed components may include animal protein meal, fish oil, palm fat, or fiber sources.

In various implementations and alternatives, the marine attractant feed block has a length of at least 3 inches and volume of at least 21 cubic inches. In addition or alternatively, the marine attractant feed block product is of a cylindrical shape, the marine attractant feed block product may be shelf-stable in ambient air at ambient temperatures for at least four weeks, and for instance a portion of the marine attractant feed block product remains intact after being submerged in water for about 12 hours.

### BRIEF DESCRIPTION OF THE DRAWINGS

FIG. 1 is a photograph of a log-shaped stable marine feed attractant product according to the present disclosure arranged in a trap configured for submersion in flowing water.

FIG. 2 is a photograph of a log-shaped stable marine feed attractant product prior to submersion in flowing water (left), and a plurality of such products after submersion in flowing water, according to the present disclosure (right).

### DETAILED DESCRIPTION

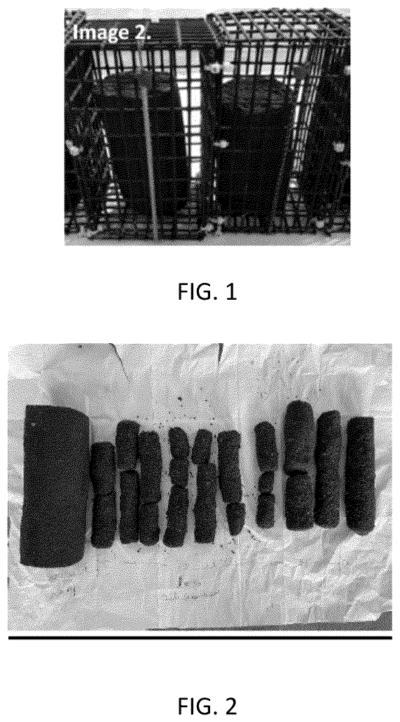

Implementations of the present disclosure provide stable marine feed attractant products and methods of their use. The composition of the stable products may be water resistant and remain at least partially intact while submerged in water, including flowing water, for an extended period of time such as about, at least about, or more than 12 hours from being submerged, which are typical periods of time during which marine traps are submerged in water before being picked-up for harvest. FIG. 1 is a photograph of log-shaped stable marine feed attractant products according to the present disclosure arranged in a respective trap configured for submersion in flowing water. The flowing water may include flowing ocean currents as provided further herein. The stable composition may slowly degrade or breakdown while submerged, thereby releasing marine feed components and attractants that form a scent trail to induce feeding behavior and/or attract the marine life back to the trap where the at least partially intact marine feed attractant product is held. FIG. 2 is a photograph of a log-shaped stable marine feed attractant product prior to submersion in flowing water (1^{st} from the left) and a plurality of such products after submersion in flowing water (2^{nd} from the left to the right). Implementations of the present disclosure are in contrast to prior approaches that submerge bait into standing water for harvesting marine life such as crawfish bait, and for instance attempts to use still water bait in traps submerged in flowing water results in the still water bait dissolving rapidly in the traps and is completely dissolved within a few hours, which is impractical for marine harvesting operations. Implementations of use may be applicable in harvesting marine life, such as harvesting marine life residing in flowing water or ocean currents, and include but are not limited to: crustaceans such as crab (e.g., blue crab), crawfish, and lobster.

The stable marine feed attractant products may contain a binder composition and one or more marine feed components and attractants. The binder composition may form a web that retains the one or marine feed components and attractants in the product, and binder and marine feed components and attractants may be evenly distributed throughout the product. The product may be a cured or hardened block that retains its initial shape until being submerged in water. For instance, and as provided further herein, where the product is placed in a trap or other vessel with openings for marine life, the product may retain its shape therein until after the trap or vessel is submerged. Due to its intended use in water to attract marine life, the product may be biodegradable, edible, digestible, and formed of components generally recognized as safe (GRAS).

The binder composition may provide water resistance and stability to the product, and may include a combination of: an edible polymer and a hardening agent along with other binder components such as moisture and/or a sugar component. The binder composition may be present in the product at about 12 to about 50 wt. %, about 15 to about 45 wt. %, about 20 to about 45 wt. %, about 25 to about 40 wt. %, about 30 to about 50 wt. %, about 30 to about 40 wt. %, about 35 to about 45 wt. %, about 40 to about 50 wt. % or about 15, 20, 25, 30, 35, 40, 45, or 50 wt. % of the product on a dry matter basis. Where too much binder is present, the product may not bind together or provide a product that retains its shape. As provided herein, it has been discovered that the binder composition provides stability to the marine feed attractant product, which may allow the product to be shelf-stable for extended periods of time; and remain in flowing water for extended periods of time, at a range of water temperatures, at a range of salinities, and combinations. In the product, the binder composition may be in a post-reacted state in which the edible acid and gelatinized starch have cross-linked to promote polymerization or cross-linking, and hardening of the binder composition has occurred in which the hardening agent (e.g., magnesium oxide) has hardened or exothermed in the other binder component(s). In some examples, the hardened binder composition results in a product that is non-pliable and the product retains its initial shape until a period of time after being submerged in water. In some examples, the product may have a hardness ranging from about 15 to about 40 psi using a pin tester with a pin diameter of ⅜ in.

The edible polymer may be formed of an edible acid and gelatinized starch, which may facilitate binding the feed components and attractants in the product because the polymerized or cross-linked polymer of the edible polymer may form or contribute to forming a web that serves to retain the feed components and attractants in a stable product until a respective portion of the polymer web has dissolved upon submerging in water during use. The edible polymer may be present in the binder composition at about 4 wt. % to about 15 wt. %, about 4 wt. % to about 10 wt. %, about 4 wt. % to about 8 wt. %, or about 4 wt. % to about 6 wt. % of the binder composition on a total weight basis.

The starch of the edible polymer may be a gelatinized starch derived from one or more starch sources including but not limited to: cereal grain such as corn grain, corn flour, corn silage, corn starch, corn byproducts, sorghum grain, sorghum silage, sorghum byproducts, milo, wheat grain, wheat flour such as 2nd clear flour, wheat silage, wheat bran, red dog wheat, wheat flour, red dog wheat flour, wheat middlings, wheat byproducts, barley grain, barley flour, barley silage, barley byproducts, oat grain, oat flour, oat silage, oat byproducts, bakery byproducts, hominy feed, peas, malt sprouts, rice, rice flour, rice byproducts, cereal feed, sucrose, lactose, glucose, dextrose, maltose, and tubers such as potatoes, yams, sweet potatoes, cassava, and arrow root. In some implementations the gelatinized starch may include a gelatinized grain-based flour. Further, the gelatinized starch may be hydrated due to gelatinization occurring in the presence of water.

The cross-linker of the edible polymer may include edible acids such as but not limited to: acetic acid, citric acid, fumaric acid, lactic acid, malic acid, phosphoric acid, propionic acid, and tartaric acid. Acetic acid may be in the form of vinegar.

The cross-linker and starch of the edible polymer may be provided in varying amounts relative to each other. For instance, the cross-linker may account for about 5 to about 25 wt. %, about 5 to about 15 wt. %, about 5 to about 10 wt. %, or about 5, 6, 7, 8, 9, 10, 12, 14, 15, 16, 18, 20, 22, 24 or 25 wt. % of the edible polymer, while a balance may be provided by the starch. For instance, the starch may account for about 75 to about 95 wt. %, about 85 to about 95 wt. %, about 90 to about 95 wt. %, or about 75, 76, 77, 80, 82, 85, 88, 90, or 95 wt. % of the edible polymer.

U.S. Pat. No. 11,388,913 B2 discloses methods of manufacture and use of a starch-based substitute fiber material, and is commonly owned and incorporated herein by reference in its entirety for any purpose. In contrast to U.S. Pat. No. 11,388,913 B2, the binders and products of the present disclosure are, in implementations, free of a plasticizer such as arabitol, erythritol, glycerin, isomalt, lactitol, maltitol, mannitol, sorbitol or xylitol. It has been discovered that the binder compositions and products of the present disclosure have a strength or hardness conducive to providing a stable product in water, whereas the use of a plasticizer in such binder compositions or products results in a pliable or rapidly dissolving product that is incompatible for use as a marine feed attractant.

The hardening agent in the binder composition may facilitate providing a cured or hardened composition, and during production the hardening agent may exotherm to provide heat for facilitating curing, hardening, polymerization and/or cross-linking of the binder and combinations thereof. Hardening agents may include but are not limited to: magnesium oxide, calcium oxide, calcium hydroxide, and ionic salts of magnesium or calcium. The hardening agent may be present in the binder composition at about 4 wt. % to about 12 wt. % of the binder composition on a total weight basis. For instance magnesium oxide may be present in the binder composition at about 4 wt. % to about 8 wt. % of the binder composition on a total weight basis of the binder.

The hardening agent may be activated by moisture, such as water. The moisture or water facilitates reaction by the hardening agent. Water such as added water may be present in the binder composition at 5 to 50 wt. % of the composition on a total weight basis, such as about 5 to about 40 wt. % water, about 5 to about 10 wt. % water, about 5 to about 20 wt. % water, about 5 to about 30 wt. % water, about 10 to about 40 wt. % water, about 20 to about 40 wt. % water, about 20 to about 30 wt. % water, about 20 to about 25 wt. % water, or about 5, 8, 10, 15, 20, 25, 30, 35, 50, 45, 50 wt. % water on a total weight basis of the binder.

In some implementations, a sugar component may be in liquid form and may provide a water source. Where a liquid sugar component is used as a source of moisture, the hardened sugar component in the product may provide for a slower rate of degradation in water compared to the edible polymer while also contributing to a hardness of the product. In some implementations, the sugar component may be provided as a syrup, and such syrups may for instance include but are not limited to: molasses, high fructose corn syrup, syrups containing one or more of sucrose, fructose, glucose, and combinations. The sugar syrup may contain about 20 to about 40 wt. % moisture, about 20 to about 30 wt. % moisture, about 20 to about 25 wt. % moisture, or about 20, about 22, about 24, about 26, about 28, about 30, about 35, or about 40 wt. % moisture. A moisture content of molasses is generally about 20 to about 25 wt. %. Molasses may be provided in the form of cane molasses or beet molasses. Inclusion of one or more sugar components may promote increased water stability of the product to impart shelf-stability when the product is stored in ambient conditions, e.g., ambient air and temperatures, and due to the water soluble nature of sugars may promote dissolution of the binder once the product is submerged in water. When present, the one or more sugar components may be present in the binder composition at about 35 wt. % to about 90 wt. %, about 50 wt. % to about 90 wt. %, about 70 wt. % to about 90 wt. %, about 75 wt. % to about 85 wt. %, about 75 wt. % to about 90 wt. %, or about 80 wt. % to about 90 wt. % on a total weight basis of the binder composition. In implementations where the sugar component is not present in the binder, as will be understood, the edible polymer, hardening agent and water may be present at increased percentages in the binder. For instance the edible polymer and hardening agent may individually be present in the binder at about, up to about, or at least about, 16, 18, 20, 22, 25, 28, or 30 wt. % on a total weight basis of the binder composition. Water may account for about, up to about, or at least about, 60, 70, 80, or 90 wt. % on a total weight basis of the binder composition.

Other binder components may include but are not limited to pellet binders such as urea formaldehyde binders including Unibond and Pelheasion.

Marine feed components and attractants in the stable marine feed attractant products may serve to attract and/or provide a source of nutrients for marine life, such as marine life to be harvested. The marine feed components and attractants may be present in the product at about 40 to about 70 wt. % of the product, about 40 to about 60 wt. %, about 40 to about 50 wt. %, about 50 to about 70 wt. %, about 50 to about 60 wt. %, about 55 to about 70 wt. %, about 55 to about 65 wt. %, or about 40, 45, 50, 55, 60, 65, 70, 75, 80, 85 or 90 wt. % of the product on a dry matter basis.

Marine attractants and feed components that may be included in the stable marine feed attractant product may include but are not limited to: animal protein products including but not limited to animal protein meal, feather meal, fish meal, meat and bone meal, poultry by-product meal, shrimp meal, fish solubles, and combinations thereof, dried whey, dried whey solubles, whey permeate, blood meal, and poultry meal, soy hulls, fish oil, soy oil, beet pulp, oat mill byproduct, cottonseed meal, dried egg product, roughage products such as oat mill by-products, and one or more of the various starch sources including but not limited to cereal grain such as corn grain, corn flour, corn silage, corn starch, corn byproducts, sorghum grain, sorghum silage, sorghum byproducts, milo, wheat grain, wheat flour, wheat silage, wheat bran, red dog wheat, wheat flour, wheat middlings, wheat byproducts, barley grain, barley flour, barley silage, barley byproducts, oat grain, oat flour, oat silage, oat byproducts, bakery byproducts, hominy feed, peas, malt sprouts, rice, rice flour, rice byproducts, cereal feed, sucrose, lactose, glucose, dextrose, maltose, and tubers such as potatoes, yams, sweet potatoes, cassava, and arrow root. The starch sources may be non-gelatinized or gelatinized. The attractants and feed components may include one or more of the aforementioned components. Where more than one component is included, these may be present a for instance at 1-99 wt. % of the attractants and feed components. In some examples, one component may account for about 5 to about 10 wt. %, about 5 to about 20 wt. %, about 5 to about 30 wt. %, about 10 to about 40 wt. %, about 20 to about 40 wt. %, about 20 to about 50 wt. %, about 20 to about 30 wt. %, about 20 to about 25 wt. %, about 5 to about 50 wt. %, about 50 to about 99 wt. %, about 50 to about 90 wt. %, about 60 to about 95 wt. %, about 60 to about 80 wt. %, about 70 to about 98 wt. %, about 80 to about 99 wt. %, about 85 to about 99 wt. %, about 90 to about 99 wt. %, about 95 to about 98 wt. %, about 95 to about 99 wt. %, or any range therebetween of the attractants and feed components, while one or more other components, such as a second, third, fourth, fifth, and sixth component accounts for a balance thereof.

In some implementations where a sugar component such as molasses is not included in the binder, the sugar component may be included in the marine feed components and attractants. Alternatively, where the sugar component is included in the binder, a sugar component may also be included in the marine feed components and attractants.

The marine feed components and attractants may be evenly distributed throughout the products of the present disclosure and for instance the marine feed components and attractants and the binder may be homogenously distributed through such products.

The products of the present disclosure may include a dry matter content of about 75 to about 90 wt. %, about 80 to about 90 wt. %, about 85 to about 90 wt. % with the balance moisture as provided herein. Nutrients in the dry matter may include but are not limited to protein, fat, fiber, ash, lignin, vitamins and minerals, and a residual hardening agent such as magnesium or calcium.

Protein may account for about 20 to about 60 wt. %, about 25 to about 50 wt. %, about 30 to about 50 wt. %, about 40 to about 50 wt. %, or about 25, 30, 35, 40, 45, or 50 wt. % of the dry matter on a dry matter basis. Fat may account for about 7 to about 15 wt. %, about 10 to about 15%, or about 7, 8, 9, 10, 11, 12, 13, 14, 15 wt. % of the dry matter on a dry matter basis. Fiber may account for about 20 to about 40 wt. %, about 25 to about 40 wt. % about 25 to about 35 wt. %, about 30 to about 40 wt. % or about 25, 30, 35 or 40 wt. % of the dry matter on a dry matter basis. Ash may account for about 20 to about 60 wt. %, about 25 to about 50 wt. %, about 30 to about 50 wt. %, about 40 to about 50 wt. %, or about 25, 30, 35, 40, 45, or 50 wt. % of the dry matter on a dry matter basis. Lignin may account for about 0.25 to about 3.0 wt. %, about 0.5 to about 2.0 wt. %, about 0.75 to about 1.5 wt. %, or about 0.5, 0.75, 1.0, 1.25, 1.5, 1.75, 2.0, 2.5 or 3.0 wt. % of the dry matter on a dry matter basis. Vitamins and minerals may account for about 2 to about 10 wt. %, about 4 to about 8 wt. %, or about 2, 3, 4, 5, 6, 7, or 8 wt. % of the dry matter on a dry matter basis. Magnesium or other hardening agent derivative such as calcium, may account for about 0.25 to about 3.0 wt. %, about 0.5 to about 2.0 wt. %, about 0.75 to about 1.5 wt. %, or about 0.5, 0.75, 1.0, 1.25, 1.5, 1.75, 2.0, 2.5 or 3.0 wt. % of the dry matter on a dry matter basis.

The products of the present disclosure may contain some moisture bound within the binder as well as being present in the marine feed components and attractants, however, due to the nature of the moisture being bound within the composition of the product itself, the product exhibits increased water stability and shelf stability as provided herein. In some cases, moisture in the product may account for about 10 to about 25 wt. %, about 10 to about 20 wt. %, about 12 to about 22 wt. %, about 14 to about 20 wt. %, about 15 to about 18 wt. %, or about 10, 11, 12, 13, 14, 15, 16, 17, 18, 19, 20, 21, 22, 23, 24, 25 of the product.

The stable marine feed attractant products may take any form suitable for submerging in water and/or attracting marine life. For instance, the products may be configured to be held in a trap configured for marine life such as a wire, cube- or half cylinder-shaped trap. In exemplary uses, the products are configured to fit within a trap 8 in. in height. In some examples, the products are in the form of a marine attractant feed block. Marine attractant feed blocks may take any form or geometry suitable for submerging in water and/or attracting marine life. For instance, the marine attractant feed blocks may be cylinder or log-shaped, cube-shaped, spherical and so on. The marine attractant feed blocks may have a length of at least 2 inches, 3 inches, 4 inches, 5 inches, 6 inches, up to 12 inches. The marine attractant feed block may have a diameter of at least 2 inches, 3 inches, 4 inches, 5 inches, or 6 inches for instance when the marine attractant feed block is cylindrically shaped or has a polygonal cross-section (e.g., hexagonal, pentagonal, or octagonal shape). Similarly, the marine attractant feed block may have a height and or width of at least 2 inches, 3 inches, 4 inches, 5 inches, 6 inches, 7 inches, or 8 inches, for instance when the marine attractant feed block is cube-shaped, or may have the aforementioned heights for instance when the marine attractant feed block is cylindrically shaped or has a polygonal cross-section. In one example, the marine attractant feed block has a length of at least 2 inches and volume of at least 8 cubic inches. In another example, the marine attractant feed block is cylindrically shaped and has a length of at least 3 inches, a diameter of about or at least about 3 inches, and a volume of at least 21.2 cubic inches. In other examples, the marine attractant feed block has a volume of up to about 20, 21, 22, 23, 24, 25, 26, 27, 28, 29, 30, 64, 125 or 216 cubic inches. In addition or alternatively, the marine attractant feed block may be configured with a size and shape adapted to be received in a specific region of a trap configured for holding bait. An initial weight of the marine attractant feed block may have an initial weight of about 1 lb., 2 lbs., 3 lbs., 4 lbs., 5 lbs., 6 lbs.

In some implementations, the marine attractant feed block may have a fat coating, such as a palm fat coating. In some implementations, the product composition may be free of materials such as alginate, gelatin, acacia, agar, agarose, carrageenan, guar gum, pectin, collagen and synthetic polymers, such as polyvinylpyrrolidone, polyalkylene glycols, EDTA, urea, urea formaldehyde binders (e.g., pellet binders), calcium lignin sulfonate, or calcium chloride, or a fat coating. In other implementations, the product composition may include one or more of the aforementioned materials in amounts that are insubstantial or insufficient to serve as the binder. In addition or alternatively, one or more of the disclosed binder components and marine feed components and attractants may be excluded.

Although components of the stable marine feed attractant products have been included in land animal feed products, such as those disclosed in Skoch et al. (U.S. Pat. No. 4,171,385 A), which discloses ruminant feed blocks containing magnesium oxide and molasses in poured animal feed blocks for use in applications with livestock animals such as in-pasture ruminants, and Burr et al. (U.S. Pat. No. 11,388,913 B2) that discloses a blend of acid and starch from cereal grains to form a bioplastic that could be consumed by livestock land animals as a fiber replacement, none of these components have been used in applications where the product is submerged in water, nor have these been used in providing stable marine feed attractant products. Further, the marine attractant feed blocks of the present disclosure have a physical size that differs from the ruminant feed blocks and the bioplastic shreds of the aforementioned prior approaches. In particular, the present disclosure manipulates a surface area of the product to adjust a rate of dissolution compared to bioplastic shreds having a maximum volume of 15 cubic inches disclosed in Burr et al. and that accelerates dissolution from commercially available ruminant feed blocks weighing 100-250 lbs. where for instance a 225 lb. feed block has a volume of 8,860 cubic inches and which is contained in a plastic tub with an open top (see Purina Rangeland Cattle Tub). Consequently, the stable marine feed attractant products of the present disclosure provide discoveries over prior approaches in that the stable marine feed attractant products herein, among other things, provide an artificial bait product with a size and shape that is both partially dissolved and remains partially intact after at least 12 hours in water.

The marine attractant feed product may be produced by blending and heating binder components along with water to a gelatinization temperature of the starch (e.g., to about 120° F. to about 180° F. depending on the starch source) where the gelatinized starch and cross-linker form the edible polymer along with the hardening agent, and optionally other binder components such as a sugar source, and the edible polymer forms an adhesive, water resistant mass. During production, the hardening agent reacts at least with the gelatinized starch cross-linked with the acid to produce the binder, which may be blended with the attractant and feed components at the inclusion rates disclosed herein. This mixture may be compressed into a final form, such as into a feed block, which may have various shapes, sizes and volumes as disclosed herein. For instance, a cylindrical feed block may have a diameter of at least 3 inches and a length of at least 3 inches. A variety of shapes of the feed block are possible and for instance using die defining a cylindrical, circular, square, rectangular, or other polygon shape disclosed herein, which may be used to form the feed block such as via extrusion. Once the products are formed, they may be placed in a warm, dry area for about 12 hours or more to promote a complete reaction of the hardening agent and cross-linking of the starch and acids to provide a finished product. In some implementations, storage for 7-14 days thereafter may promote water stability of the product. The finished products may be shelf-stable for the extended periods of time as disclosed herein. Further, the finished products may be pre-formed and may retain their original shape until use. The finished product may have a hardness ranging from about 15 to about 40 psi using a pin tester with a pin diameter of ⅜ in., and the harness of the product may increase after storage for 1 week, 2 weeks, 4 weeks and in some implementations at least 3 months.

In implementations of use, a marine attractant feed product, such as one or more blocks, may be submerged in water to cause marine life to be attracted thereto. While submerged, a portion of the marine attractant feed block(s) gradually dissociate over time while another portion remains intact as the marine attractant feed block over a pre-defined duration of time as provided herein, and marine life is attracted to the dissociated portions and/or to the portion(s) of the marine attractant feed block that remains intact. The water in which the marine attractant feed block is submerged may be flowing water such as an ocean current. The flowing water may have a temperature of about 45° F. to about 90° F. or ambient temperatures of sea water in oceans and freshwater where marine life is to be harvested. For instance, the flowing water may be about 50° F. to about 60° F., which may be the ambient temperature of ocean water where marine life can be harvested. The flowing water may have a salinity of sea water which is about 33 to about 37 grams per liter. Similarly sea water may contain salt at a level of about 33 to about 37 parts per thousand of water. Alternatively, the flowing water may be fresh water or may be partially fresh water and sea water, e.g., where a river feeds to an ocean, and for instance salinity may be about 6 parts per thousand.

The binder compositions may stabilize the marine attractant and feed components in flowing water as provided herein. For instance, the marine attractant feed block may trap a marine attractant and/or feed component in the binder composition due to web formed by the cross-linked edible polymer, sugar component, hardening agent and other binder components distributed therein, where this web retains the marine attractant and feed components. While submerged in flowing water, the polymer web of the marine attractant feed block slowly dissolves and releases the marine attractant and feed components positioned at an external surface thereof, and upon release, a newly exposed exterior surface of the polymer web begins to dissolve and release further marine attractant and feed components. The released marine attractant and feed components forms a feed and scent trail for attracting the marine life to the feed block. After a pre-defined period of time, at least a portion of the marine attractant feed block remains intact to promote a prolonged attractant period for marine life to be harvested. This may enable the marine attractant feed block to be placed in a trap configured for holding marine life such as crustaceans.

In use, the stable marine feed attractant product may remain partially intact for extended periods of time after being submerged in water, such as at least, up to or more than: 8 hours, 12 hours, 18 hours, 24 hours, 30 hours, 36 hours, 42 hours, or 48 hours after being submerged in water such as flowing water or ocean currents. In one example, the stable marine feed attractant product in having a cylinder shape with a 3 inch diameter and a 3 inch length may remain partially intact after being submerged in water, such as at least, up to or more than 8 hours, 12 hours, 18 hours, 24 hours, 30 hours, 32 hours, 34 hours, 36 hours, 42 hours, or longer such as about 47 or 48 hours. In some implementations, the stable marine feed attractant product may substantially completely dissociate after about 8 or 12 to about 14 or 18 hours, about 18 or 22 to about 24 or 26 hours or after about 42 or 44 or 46 to about 48 hours. For instance, the stable marine feed attractant product may remain at least partially intact for at least 8 hours and may substantially completely dissociate after about 12 to about 18 hours. In a further example, the stable marine feed attractant product may remain at least partially intact for at least 12 hours and may substantially completely dissociate after about 18 to about 24 hours. In yet another example, the stable marine feed attractant product may remain at least partially intact for at least 22 hours and may substantially completely dissociate after about 24 to about 30 hours. The product configuration may depend on the frequency of harvesting marine life from traps, e.g., twice daily harvesting, daily harvesting or harvesting every other day. A substantially completely dissociated feed product is one that has degraded to about 0.5 to about 10 wt. % of its original weight or degraded to about 0.5 to about 10% of its original volume. A substantially completely dissociated feed product may provide advantages over the use of traditional bait fish in that the trap does not retain a substantial amount of the bait at the time of harvesting allowing the trap operators to avoid the need for cleaning and washing of the traps between uses and also avoids generating waste.

In use, the released portions of the marine attractant and feed components may attract marine life to the intact portion of the marine attractant feed block for at least, or up to, about 12 hours, 18 hours, 24 hours, 26 hours, 30 hours, 32 hours, 36 hours, 40 hours, 42 hours, 44 hours, or 48 hours.

In use in marine life traps such as crab traps, one, two, three, four, five, six or more of the marine attractant feed blocks may be inserted into the trap for use in attracting and harvesting marine life.

In use in marine life harvesting environments, the products of the present disclosure may attract marine life at levels similar to that of by-catch fish (e.g., shad or menhaden) such as about 30, 40, 50, 60, 70, 80, 90, 100, or 110 percent or more compared to by-catch fish.

Prior to use, the stable marine feed attractant product may remain shelf-stable with low water activity for extended periods such as at least 4 weeks, at least 1 month, at least two, three, four, five, six, seven, eight, nine, ten, eleven, or twelve months, or about 6 to 12 months, about 8 to 12 months or longer, such as at least 14 months. Shelf-stability as used herein means the product remains stable at ambient conditions prior to their introduction in water.

Although the products of the present disclosure have been described as providing a marine attractant to bait marine life living in marine environments such as ocean environments including gulf conditions for harvest, the products of the present disclosure may serve as a marine attractants or feed for instance for marine life in confined spaces such as a marine life holding tank where marine life may be grown for harvesting or for study.

These and other advantages may be appreciated in the following Examples, which are intended to be illustrative, and numerous modifications and variations may be implemented in view of the present disclosure, which may be apparent to those skilled in the art.

Example 1: This Example studied the durability of the marine attractant formulation of Table 1 in simulated marine conditions over time to determine timeframes during which the marine attractant formulation breakdown.

Materials and Methods: An in-house test tank was used to mimic gulf conditions, with the test tank having dimensions of 10′×2′×23.5″ filled with approximately 260 gallons of tap water in which white granular salt was added to reach a target salinity of 6 ppt to match salinity in gulf waters in Louisiana, USA. Water temperatures were maintained above 55 OF using a stock tank heater. The salinity and temperature ranges were determined using United States Geological Survey data from stations in Vermillion Bay Intercoastal City, LA (Station ID: USGS 07387050). Salt was allowed to go into solution before testing began. An Alpine Cyclone 8000 pump (Alpine Corporation, Commerce, CA, USA) was secured in one end of the tank with water flow directed towards the body of the tank. The flow rate on the pump is between 6500-8000 gallons per hour and this mirrored maximum currents in the gulf waters in Louisiana. Maximum currents in the gulf of Louisiana were determined using National Oceanic and Atmospheric Administration tidal current readings from Calcasieu Pass, Cameron Fishing Pier (Station ID: 1c0201, depth 17 feet).

In Example 1, primary ingredients for glue in combination with marine attractants were evaluated to understand the durability of the products containing the glue ingredients listed in Table 1. Marine attractant products having the formula of Table 1 were prepared according to the methods of the present disclosure and with a starting weight of about 1.6 lbs. and a diameter of about 2 in. and were placed in standard bait cages having dimensions of 4″×4″×8″, which are the same cages used in crab fishing. The bait cages were placed approximately 24″ from the pump hose outlet. Bait cages were placed to ensure equal water flow was directed at each bait cage. The average temperature of the water in the test tank was 60.1° F.

TABLE 1
Marine Attractant Product Formulation

| Ingredients, % | TRT 1 | TRT 3 |
|---|---|---|
| Glue | | |
| Cane Molasses | 36.9 | 36.2 |
| Calcium chloride | 5.3 | 5.2 |
| Red Dog wheat flour | 2.2 | 2.2 |
| Glue Total | 44.4 | 43.6 |
| Glue | 44.4 | 43.6 |
| Animal protein meal | 46.7 | 45.8 |
| Soy Hulls | 3.7 | 3.6 |
| Salt | 1.5 | 1.5 |
| Pellet binder | 0.0 | 1.8 |
| Palm Fat | 3.7 | 3.6 |
| Total | 100.0 | 100.0 |

Results: The results of Example 1 are listed in Table 2.

TABLE 2
Percent of Marine Attractant Product remaining over time

| | Hours | | | | | | | |
|---|---|---|---|---|---|---|---|---|
| Treatment ID | 0 | 2 | 4 | 6 | 8 | 18 | 21 | 24 |
| 1 | 100.00 | 83.42 | | | | 2.33 | | |
| 3 | 100.00 | 89.52 | | | | 2.75 | | |

Summary: The glue, dry matter and fat compositions of Example 1 provides marine attractant products that remain at least partially intact for at least 18 hours in marine conditions. The addition of a binder in the dry matter composition does not appear to provide a positive impact on the stability of the product in marine conditions over time.

Example 2: This Example studied a marine attractant product having the formula of Example 1 prepared according to the methods disclosed herein with a palm fat coating applied to an exterior of the product to understand whether a fat coating impacts the durability of the marine attractant formulation in simulated marine conditions over time. All products weighed 1.5 lbs. and had a 2 in. diameter. The simulated marine conditions were the same as in Example 1 except the average temperature of the water in the test tank was 78.4° F.

Results: The results of Example 2 are listed in Table 3.

TABLE 3
Percent of Marine Attractant Product remaining over time (hours)

| Treatment | 0 | 2 | 4 | 6 | 8 | 18 | 21 | 24 |
|---|---|---|---|---|---|---|---|---|
| TRT 1 coated | 100.00 | | | | 18.99 | | | |
| TRT 1 not coated | 100.00 | | | | 17.81 | | | |
| TRT 3 coated | 100.00 | | | | 35.21 | | | |
| TRT 3 not coated | 100.00 | | | | 29.47 | | | |

Summary: The fat coating over the marine attractant products do not negatively impact the stability of the product over time.

Example 3: This Example studied marine attractant products (TRT 4 and TRT 5) having the formula listed in Table 4 prepared according to the methods disclosed herein. The formula included a different glue composition in which a pellet binder was included in the binder of TRT 5, and a different starch source were used compared to Example 1 (TRT 3), to understand the durability of the marine attractant formulation of Table 4 in simulated marine conditions over time. Trt 4 weighed 1.4 lbs. and had a 2 in. diameter, and Trt 5 weighed 1.6 lbs. and had a 2 in. diameter. The simulated marine conditions were the same as in Example 1 except the average temperature of the water in the test tank was 75.0° F.

TABLE 4
Marine Attractant Product formulation

| Ingredient, % | TRT 4 | TRT 5 |
|---|---|---|
| Glue | | |
| Cane Molasses | 83 | 83 |
| Calcium chloride | 12 | 12 |
| 2nd Clear Flour | 5 | 5 |
| Glue Total | 100 | 100 |
| Glue | 46.0 | 45.0 |
| Animal protein meal | 47.0 | 43.5 |
| Soy Hulls | 3.0 | 3.5 |
| Pellet binder | — | 4.0 |
| Palm Fat | 4.0 | 4.0 |
| Total | 100.0 | 100.0 |

Results: The results of Example 3 are listed in Table 5.

TABLE 5
Percent of Marine Attractant Product remaining over time (hours)

| Treatment ID | 0 | 2 | 4 | 6 | 8 | 18 | 21 | 24 |
|---|---|---|---|---|---|---|---|---|
| TRT 3 | 100.00 | | | | 46.29 | | | |
| TRT 4 | 100.00 | | | | 12.71 | | | |
| TRT 5 block | 100.00 | | | | 49.54 | | | |
| TRT 5 log | 100.00 | | | | 45.34 | | | |

Summary: The addition of a pellet binder (Pelheasion) in TRT 5 does not negatively impact the stability of the product over time and performs similarly to the pellet binder (Unibond) in TRT 3. However, pellet binders may not be suitable for aquatic species based on safety data sheets.

Example 4: This Example studied marine attractant products (TRT 6 and TRT 7) having the formula listed in Table 6 prepared according to the methods disclosed herein. The products in Trt 6 and 7 weighed 1.5 lbs. and had a 2 in. diameter. The formula included a different hardening agent (magnesium oxide) and included a binder (Pelheasion) in the glue composition in one formulation (TRT 7) but without a starch source, to understand the durability of the marine attractant formulation of Table 6 in simulated marine conditions over time. The simulated marine conditions were the same as in Example 1 except the average temperature of the water in the test tank was 68.3° F.

TABLE 6
Marine Attractant Product Formulation

| Ingredient, % | TRT 6 | TRT 7 |
|---|---|---|
| Glue | | |
| Cane Molasses | 90 | 82.86 |
| Water | 5 | 9.52 |
| Mag Ox HR | 5 | 3.81 |
| Pelheasion (binder) | | 3.81 |
| Glue Total | 100.00 | 100.00 |
| Glue | 45.00 | 44.63 |
| Animal protein product | 50.00 | 55.37 |
| Soy Hulls | 2.50 | 2.50 |
| Palm Fat | 2.50 | 2.50 |
| Total | 100.0 | 100.0 |

Results: The results of Example 4 are listed in Table 7.

TABLE 7
Percent of Marine Attractant Product remaining over time (hours)

| Treatment ID | 0 | 2 | 4 | 6 | 8 | 18 | 21 | 24 |
|---|---|---|---|---|---|---|---|---|
| TRT 6 | 100.00 | | | | 50.96 | | | |
| TRT 7 | 100.00 | | | | 50.01 | | | 3.15 |

Summary: The addition of a pellet binder in TRT 7 improved the stability of the product over time and results in at least a portion of the marine attractant product remaining in the trap after 24 hours of marine conditions.

Example 5: This Example studied marine attractant products (TRT 8A-8G) having the formula listed in Table 8 prepared according to the methods disclosed herein. The formula included citric acid and a starch source where the product had varying sizes (e.g., 2 in. and 3 in. diameter), to understand the durability of the marine attractant formulation of Table 8 in simulated marine conditions over time. Trt 8E2 weighed 1.2 lbs. and had a 2 in. diameter, Trt 8F weighed 1.7 lbs. and had a 3 in. diameter, and Trt 8G weighed 2.5 lbs. and had a 3 in. diameter. The simulated marine conditions were the same as in Example 1 except the average temperature of the water in the test tank was 69.7° F. (TRT 6 and TRT 8A, 8B) or 74.5° F. (TRT 8E2, 8F, 8G).

TABLE 8
Marine Attractant Product formulation

| Ingredients, % | Trt 8 |
|---|---|
| Glue | |
| Cane Molasses | 79.5 |
| Water | 10 |
| Mag Ox HR | 5 |
| Citric acid | 0.5 |
| 2nd Clear Flour | 5 |
| Glue Total | 100.00 |
| Glue | 40.02 |
| Animal protein product | 50.00 |
| Soy Hulls | 2.50 |
| Palm oil or fish oil | 2.50 |
| Total | 100 |

Results: The results of Example 5 are listed in Tables 9A and 9B.

TABLE 9A
Percent of Marine Attractant Product remaining over time (hours)

| Treatment ID | 0 | 2 | 4 | 6 | 8 | 18 | 21 | 24 |
|---|---|---|---|---|---|---|---|---|
| 6 | 100.00 | | 77.66 | | 51.01 | | | 5.12 |
| 8A (30% glue) | 100.00 | | 61.47 | | 26.40 | | | 4.38 |
| 8B (40% glue) | 100.00 | | 82.75 | | 54.71 | | | 8.88 |
| 8E2 (2 in. dia.) | 100.00 | 82.86 | | | 62.36 | | | 7.96 |
| 8F (3 in. dia.) | 100.00 | 83.92 | | | 65.34 | | | 8.41 |
| 8G (3 in. dia.) | 100.00 | 87.54 | | | 72.02 | | | 14.76 |

TABLE 9B
Percent of Marine Attractant Product remaining over time (hours)

| Treatment ID | 26 | 28 | 30 | 31 | 32 | 33 | 34 | 35 | 36 |
|---|---|---|---|---|---|---|---|---|---|
| 8E2 | | | | | | | | | |
| 8F (3 in. dia.) | | 8.41 | 6.40 | | 5.10 | | | | |
| 8G (3 in. dia.) | | 14.76 | 11.06 | | 9.07 | | | | |

Summary: The formulation in TRT 8A-8G had improved stability over time resulting in the product remaining in the trap after 24 hours of marine conditions, and after 32 hours of remaining in marine conditions for products having varying weights and diameters.

Example 6: This Example studied marine attractant products (TRT 9) having the formula listed in Table 10 prepared according to the methods disclosed herein. The formula was slightly different from TRT 8 (Table 8) (e.g., palm oil vs. fish oil) and were compared to understand the durability of the marine attractant formulation of Table 10 in simulated marine conditions over time. The products tested initially had a 3 in. diameter and weighed approximately 1.6 lbs. The simulated marine conditions were the same as in Example 1 except the average temperature of the water in the test tank was 71.1° F.

TABLE 10
Marine Attractant Product formulation

| Ingredient, % | Trt 9 |
|---|---|
| Glue | |
| Cane Molasses | 79.5 |
| Water | 10 |
| Mag Ox HR | 5 |
| Citric acid | 0.5 |
| 2^{nd} Clear Flour | 5 |
| Glue total | 100 |
| Glue | 42.11 |
| Animal protein product | 52.62 |
| Soy Hulls | 2.63 |
| Fish oil | 2.63 |
| Total | 100 |

Results: The results of Example 6 are listed in Table 11.

TABLE 11
Percent of Marine Attractant Product remaining over time (hours)

| Treatment ID | 0 | 2 | 4 | 6 | 8 | 18 | 21 | 24 | 25 |
|---|---|---|---|---|---|---|---|---|---|
| 8 | 100.00 | 92.31 | | | 75.56 | | | 21.54 | |
| 9 | 100.00 | 87.85 | | | 60.99 | | | 9.86 | |

| Treatment ID | 26 | 28 | 30 | 31 | 32 | 33 | 34 | 35 | 36 |
|---|---|---|---|---|---|---|---|---|---|
| 8 | | 14.90 | | 11.01 | 9.76 | | | | |
| 9 | | 5.10 | | 3.51 | 2.84 | | | | |

Summary: The formulation in TRT 9, like the formulation of TRT 8, had improved stability over time resulting in the product remaining in the trap after 32 hours of exposure in marine conditions for products having a starting weight of 1.6 lbs. and a 3 in. diameter.

Example 7: This Example studied marine attractant products (TRT 10, 11, 12) having the formula listed in Table 12 prepared according to the methods disclosed herein. The formula was slightly different from TRT 8 and 9, with the inclusion of different fiber sources instead of soy hulls. TRT 10 included beet pulp; TRT 11 included cottonseed meal; and TRT 12 included oat mill byproduct at the inclusion rates listed in Table 12. The product compositions were compared to understand the durability of the marine attractant formulation of Table 12 in simulated marine conditions over time. The products tested had a 3 in. diameter and weighed approximately 1.6 lbs. for Trt 10, 1.8 lbs. for Trt 11, and 1.7 lbs. for Trt 12. The simulated marine conditions were the same as in Example 1 except the average temperature of the water in the test tank was 72.2° F.

TABLE 12
Marine Attractant Product formulation

| Ingredient | Trt 10, 11, 12 |
|---|---|
| Glue | |
| Cane Molasses | 79.50 |
| Water | 10.00 |
| Mag Ox HR | 5.00 |
| Citric acid | 0.50 |
| 2nd Clear Flour | 5.00 |
| Glue Total | 100.00 |
| Glue | 42.12 |
| Animal protein product | 52.62 |
| Beet pulp (BP) or cottonseed meal | 2.63 |
| (CSM), or oat mill byproduct (OMB) | |
| Fish oil | 2.63 |
| Total | 100 |

Results: The results of Example 7 are listed in Table 13.

TABLE 13
Percent of Marine Attractant Product remaining over time (hours)

| Treatment ID | Hrs. 0 | 2 | 4 | 6 | 8 | 18 | 21 | 24 | 25 |
|---|---|---|---|---|---|---|---|---|---|
| TRT 10 BP | 100.00 | 81.22 | | | 55.98 | | | 4.35 | |
| TRT 11 CSM | 100.00 | 78.65 | | | 52.56 | | | 3.65 | |
| TRT 12 OMB | 100.00 | 84.98 | | | 66.88 | | | 17.07 | |

| Treatment ID | Hrs. 26 | 28 | 30 | 31 | 32 | 33 | 34 | 35 | 36 |
|---|---|---|---|---|---|---|---|---|---|
| TRT 10 BP | 2.84 | 0.00 | | | | | | | |
| TRT 11 CSM | 0.00 | | | | | | | | |
| TRT 12 OMB | 13.90 | 10.67 | | 7.82 | 6.23 | | | | |

Summary: The formulations in TRT 10, 11 and 12, had improved stability over time resulting in the product remaining in the trap after 24 hours (TRT 10 and 11) and after 32 hours (TRT 12) of exposure in marine conditions for products having a 3 in. diameter.

Field Test 1: Marine attractant products were tested in gulf conditions in Louisiana, USA to determine crab catch rate. There were two consecutive days of testing. Crab traps were baited with a total of 16 log baited traps having the formula listed in Table A (TRT 17) produced according to the methods of the present disclosure, and a control of 16 fish (pogey) baited traps that were baited in an alternating manner. The starting log weights were about 2.5 lbs. and a 3 in. diameter. Typical bait is 3 average size pogey per trap (approximately 1 pound). The average catch for a 48 hour pogey set is about 6 to 8 crabs per trap.

TABLE A
TRT 17 Marine Attractant Product formulation

| Ingredient | % |
|---|---|
| Glue | |
| Cane Molasses | 79.5 |
| Water | 10.0 |
| Mag Ox HR | 5.0 |
| Citric acid | 0.5 |
| 2^{nd} Clear Flour | 5.0 |
| Total | |
| Glue | 42.1 |
| Animal protein product | 55.3 |
| Fish oil | 2.6 |

Results: After two consecutive days of harvesting, the residual amount of the marine attractant products was about 15 wt. % of the original log. The average catch per log bait was 0 to 3 crabs per trap, and the average catch for the fish-baited traps was 4 to 6 crabs per trap.

Summary: Although use of the marine attractant product logs caught 25-30% compared to fish-baited traps, the benefits of using the marine attractant product logs such as being substantially dissolved after at least 24 hours of being submerged in marine conditions resulting in reduced waste and clean-up time for harvesters may result in an increased efficiency in a harvesting cycle allowing for more traps to be harvested having the over the same period of time compared to fish-baited traps.

Field Test 2: In this field test, the marine attractant products were tested in gulf conditions in Louisiana, USA according to the method described in Field Test 1. The marine attractant products had the formula listed in Table B (TRT 17 FS) produced according to the methods of the present disclosure including an animal protein product in the glue, in contrast to Table A of Field Test 1.

TABLE B
TRT 17 + Animal protein product in
glue Marine Attractant Product formulation

| Ingredients | % |
|---|---|
| Glue | |
| Cane Molasses | 73.2 |
| Water | 6.3 |
| Animal protein product | 10 |
| Mag Ox HR | 5 |
| Citric acid | 0.5 |
| 2nd Clear Flour | 5 |
| Total | 100 |
| Glue | 42.1 |
| Animal protein product | 55.3 |
| Fish Oil | 2.6 |

Results: The formulation with animal protein product in the glue resulted in the product dissolving in gulf conditions too quickly for crab to be caught.

Summary: Animal protein product in the glue portion of the product formula does not appear to be compatible for gulf conditions.

Example 8: This Example studied marine attractant products (TRT 18 and TRT 19) where TRT 18 had the formula listed in Table A of Field Test 1 and TRT 19 had the formula listed in Table A except the corn flour was substituted for the 2nd clear flour. The product compositions were compared to understand the durability of such marine attractant formulations in simulated marine conditions over time. The products tested had a 3 in. diameter and weighed approximately 2.8 lbs. for Trt 18 and 2.7 lbs. for Trt 19. The simulated marine conditions were the same as in Example 1 except the average temperature of the water in the test tank was 71.0° F.

Results: The results of Example 8 are listed in Table C.

TABLE C
Percent of Marine Attractant Product remaining over time (hours)

| Treatment ID | Hrs. 0 | 2 | 4 | 6 | 8 | 18 | 21 | 24 | 25 |
|---|---|---|---|---|---|---|---|---|---|
| TRT 18 - wk0 | 100.00 | | 82.78 | | 65.65 | | | 20.43 | |
| TRT 19 - wk0 | 100.00 | | 77.03 | | 57.91 | | | 11.01 | |

| Treatment ID | Hrs. 26 | 28 | 30 | 31 | 32 | 33 | 34 | 35 | 36 |
|---|---|---|---|---|---|---|---|---|---|
| TRT 18 - wk0 | | 13.26 | 9.77 | | 6.65 | | | | |
| TRT 19 - wk0 | | 5.18 | 2.84 | | 1.10 | | | | |

Summary: The formulations in this example demonstrate that the amount of product remaining in the trap over time can be fine-tuned by adjusting glue components such as the starch source, and the use of 2nd clear flour may provide a longer lasting product compared to the use of corn flour.

Example 9: This Example studied marine attractant products, where TRT 20 had increased starch gelatinization and a reduced amount of cane molasses. The products tested had a 3 in. diameter and weighed approximately 2.3 lbs. The simulated marine conditions were the same as in Example 1 except the average temperature of the water in the test tank was 71.0° F. for TRT 20.

TABLE D
Marine Attractant Product formulation

| Ingredient, % | Trt 20 |
|---|---|
| Glue | |
| Cane Molasses | 30.3 |
| Water | 46.7 |
| Mag Ox HR | 7.6 |
| Citric acid | 1.8 |
| 2nd Clear Flour | 14.5 |
| Glue Total | 100.0 |
| Glue | 33 |
| Animal protein product | 64 |
| Fish oil | 2.6 |
| Total | 100 |

Results: The results of Example 9 are listed in Table E.

TABLE E
Percent of Marine Attractant Product remaining over time (hours)

| Treatment ID | 0 | 2 | 4 | 6 | 8 | 11 | 21 | 24 | 25 |
|---|---|---|---|---|---|---|---|---|---|
| TRT 20 | 100.00 | 0.00 | | | | | | | |

Summary: Relative to the other treatments disclosed herein that contain more sugar or non-gelatinous binding components, the use of higher amounts of gelatinous flour like in TRT 20 dissolved quickly, illustrating that glues containing more sugar binding components such as cane molasses may improve the durability of marine attractant products when subjected to marine conditions.

Example 10: This Example studied marine attractant products (TRT 18 and TRT 19) having the product formulations of Table F to understand the durability of such marine attractant formulations after being stored at ambient conditions over a 0 week, 2 week and 4 week period and then subjected to simulated marine conditions over time. The products tested in Trt 18 and Trt 19 had a diameter of about 2.8 in. and 2.9 in. respectively, and weighed approximately 2 lbs. The simulated marine conditions were the same as in Example 1 except the average temperature of the water in the test tank was 65.1 F for tested products at weeks 0 and 2 and 74.4° F. for tested products at week 4.

TABLE F
Marine Attractant Product formulation

| Ingredient, % | Trt 18 | Trt 19 |
|---|---|---|
| Glue | | |
| Cane Molasses | 73.2 | 73.2 |
| Water | 6.3 | 6.3 |
| Animal protein product | 10.0 | 10.0 |
| Mag Ox HR | 5.0 | 5.0 |
| Citric acid | 0.5 | 0.5 |
| 2nd Clear Flour | 5.0 | — |
| Corn Flour | — | 5.0 |
| Glue | 42.1 | 42.1 |
| Animal protein product | 55.3 | 55.3 |
| Fish oil | 2.6 | 2.6 |
| Total | 100 | 100 |

Results: The results of Example 10 are provided in Tables G and H.

TABLE G
Percent of Marine Attractant Product remaining over time (hours) shelf life of 0 wks. and 2 wks.

| Treatment ID | 0 | 2 | 4 | 6 | 8 | 18 | 21 | 24 | 25 |
|---|---|---|---|---|---|---|---|---|---|
| TRT 18 - wk 0 | 100.00 | | 82.78 | | 65.65 | | | 20.43 | |
| TRT 19 - wk 0 | 100.00 | | 77.03 | | 57.91 | | | 11.01 | |
| Treatment ID | 26 | 28 | 30 | 31 | 32 | 33 | 34 | 35 | 36 |
| TRT 18 - wk 0 | | 13.26 | 9.77 | | 6.65 | | | | |
| TRT 19 - wk 0 | | 5.18 | 2.84 | | 1.10 | | | | |

Percent of crab log remaining over time (hours)

| Treatment ID | 0 | 2 | 4 | 6 | 8 | 18 | 21 | 24 | 25 |
|---|---|---|---|---|---|---|---|---|---|
| TRT 18 - wk 2 | 100.00 | | 85.35 | | 69.28 | | | 22.34 | |
| TRT 19 - wk 2 | 100.00 | | 84.34 | | 66.46 | | | 17.15 | |
| Treatment ID | 26 | 28 | 30 | 31 | 32 | 33 | 34 | 35 | 36 |
| TRT 18 - wk 2 | 16.95 | 12.95 | 9.70 | | 7.39 | | 5.37 | | |
| TRT 19 - wk 2 | 14.30 | 11.53 | 7.49 | | 5.77 | | 3.61 | | |

TABLE H
Percent of Marine Attractant Product remaining
over time (hours) shelf life of 4 wks.

| Treatment ID | Hrs. 0 | 2 | 4 | 6 | 8 | 18 | 21 | 24 | 25 |
|---|---|---|---|---|---|---|---|---|---|
| TRT 18 - wk 4 | 100.00 | | 78.82 | | 63.82 | | | 15.11 | |
| TRT 19 - wk 4 | 100.00 | | 73.74 | | 55.98 | | | 17.06 | |

| Treatment ID | Hrs. 26 | 28 | 30 | 31 | 32 | 33 | 34 | 35 | 36 |
|---|---|---|---|---|---|---|---|---|---|
| TRT 18 - wk 4 | | 11.95 | | | 5.84 | 5.14 | | 2.81 | 2.09 |
| TRT 19 - wk 4 | | 10.57 | | | 5.17 | 4.56 | | 2.69 | 1.77 |

Summary: A comparison of the formulations in TRT 18 and TRT 19 shows that products stored at ambient air conditions increased durability and lasted at least 36 hours in marine conditions after storage for 4 weeks.

Although the present disclosure provides references to preferred embodiments, persons skilled in the art will recognize that changes may be made in form and detail without departing from the spirit and scope of the invention.

What is claimed is:

1. A method of attracting marine life, comprising:
submerging a marine attractant feed block in water for at least 12 hours, the marine attractant feed block comprising at least one of a marine feed or attractant, a binder composition, the binder composition comprising a hardening agent and a cross-linked edible polymer comprised of an edible acid and a gelatinized starch, and a sugar component, wherein the at least one of the marine feed or attractant is retained within a web defined by the binder and distributed throughout the marine attractant feed block,
wherein while the marine attractant feed block is submerged, a portion of the marine attractant feed block dissociates from the marine attractant feed block and another portion of the marine attractant feed block remains intact after about 12 hours, and
wherein marine life is attracted to one or more of the portion of the marine attractant feed block dissociated from the marine attractant feed block or to the portion of the marine attractant feed block that remains intact.

2. The method of claim 1, wherein the water is flowing water.

3. The method of claim 2, wherein the flowing water is at a temperature of about 45° F. to about 90° F. or wherein the flowing water has a salinity of about 33 to about 37 grams per liter or salt at a level of about 33 to about 37 parts per thousand of water.

4. The method of claim 1, wherein the marine attractant feed block is substantially completely dissociated after about 18 to about 24 hours or after about 42 to about 48 hours.

5. The method of claim 1, wherein the marine life attracted is crustaceans.

6. The method of claim 1, wherein the marine attractant feed block is arranged in a trap configured for holding the marine life.

7. The method of claim 1, wherein the marine attractant feed block has a length of at least 3 inches and volume of at least 21 cubic inches.

8. A method of stabilizing at least one of a marine feed or attractant in flowing water, comprising:
providing a hardened marine attractant feed block that retains an initial shape, the feed block comprising at least one of a marine feed or attractant in a binder composition, the binder composition comprising a hardening agent and a cross-linked edible polymer, the cross-linked edible polymer comprising an edible acid and gelatinized starch and is hardened by the hardening agent, and wherein the at least one of the marine feed or attractant is present within a web defined by the binder and distributed throughout the marine attractant feed block; and
submerging the marine attractant feed block in the flowing water, wherein the initial shape of the marine attractant feed block gradually dissolves in the flowing water and releases the at least one of the marine feed or attractant residing at an exterior thereof, and at least a portion of the marine attractant feed block remains intact after about 12 hours.

9. The method of claim 8, wherein the released at least one of the marine feed or attractant attracts marine life to the intact portion of the marine attractant feed block for up to at least about 48 hours.

10. The method of claim 9, wherein the marine attractant feed block is arranged in a trap configured for holding the attracted marine life that reach the intact portion of the marine attractant feed block.

11. The method of claim 8, wherein the flowing water is at least one of at a temperature of about 45° F. to about 90° F., or has a salinity of about 33 to about 37 grams per liter, or salt at a level of about 33 to about 37 parts per thousand of water.

12. A stable marine attractant feed block product, comprising:
at least one of a marine feed or attractant; and
a binder comprising a hardening agent, and a cross-linked edible polymer, the hardening agent comprising one or more of magnesium oxide, calcium oxide, calcium hydroxide, and ionic salts of magnesium or calcium, the cross-linked edible polymer comprising an edible acid and gelatinized starch, wherein the at least one of the marine feed or attractant is present within a web defined by the binder.

13. The marine attractant feed block product of claim 12, further comprising a sugar component.

14. The marine attractant feed block product of claim 12, wherein the product has a hardness of about 15 to about 40 psi using a pin tester with a pin diameter of ⅜ in.

15. The marine attractant feed block product of claim 12, wherein the product contains about 30 to about 50 wt. % of the binder.

16. The marine attractant feed block product of claim 12, wherein the one or more attractants or feed components comprise animal protein meal, fish oil, palm fat, or fiber sources.

17. The marine attractant feed block product of claim 12, wherein the marine attractant feed block has a length of at least 3 inches and volume of at least 21 cubic inches.

18. The marine attractant feed block product of claim 17, wherein the marine attractant feed block product is of a cylindrical shape.

19. The marine attractant feed block product of claim 17, wherein the marine attractant feed block product is shelf-stable in ambient air at ambient temperatures for at least four weeks.

20. The marine attractant feed block product of claim 19, wherein at least a portion of the marine attractant feed block product remains intact after being submerged in water for about 12 hours.
